(19) United States
(12) Patent Application Publication
(10) Pub. No.: US 2007/0157764 A1
(43) Pub. Date: Jul. 12, 2007

(54) Combined rear and front vehicle axle seal installation tool

(75) Inventor: Danny Williams, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/330,421

(22) Filed: Jan. 10, 2006

(51) Int. Cl. B67B 7/18

(52) U.S. Cl. 81/3.4

(57) ABSTRACT

A universal tool for installation of an annular seal for a front axle as well as a rear axle of a vehicle includes a handle, a customized body member capable of being reversibly attached to the handle for placement and insertion of one of two sizes of seals in the motor vehicle axle housing.

### BACKGROUND OF THE INVENTION

In a principal aspect the present invention relates to a tool useful for installation of rear axle and front axle seals in motor vehicles. The tool is designed to have the capability of installation of both a uniquely sized rear axle seal and a uniquely sized front axle seal wherein the front axle seal and rear axle seal may be distinctly constructed.

Vehicle manufacturers typically incorporate seals associated with the front and rear axle housing. The seals generally have a circular configuration and are fitted into the housing associated with either the rear axle or front axle. The seals are fitted into the axle housing to prevent leakage of lubricant or the like and also to enable movement of necessary component parts of the rear or front axle.

Removal of a seal from the rear axle as well as the front axle is a challenging project. Installation or replacement of seals is often more challenging. That is, both the rear axle housing and front axle housing of many vehicles are positioned in the undercarriage of a vehicle in a manner which often makes access extremely difficult. For example, the axle housing may be situated behind numerous other mechanical parts thereby inhibiting access. Consequently, when attempting to replace a seal, the mechanic seeking to perform such a task will have difficulty accessing the portion of the axle housing adapted to appropriately receive the seal.

When access is achieved, it is nonetheless often difficult to perform work on the axle housing which is to be serviced. That is, replacing a seal typically requires use of a hammer or some other tool to appropriately and completely insert the seal in the desired manner in the housing. Because the housing and the seal receiving portion thereof are difficult to access, using a hammer or other driving tool is often extremely difficult again, because of the location of the housing.

Various large SUV vehicles made by Ford, for example, sold under the trade name Explorer and Expedition exhibit the problems described. Although the manufacturer provides instructions and describes tools useful for such servicing, the tools are not generally considered to be adequate for the task. Thus, there has developed a need for an improved tool or tools useful for the installation of seals and, in particular, for the installation of seals for a rear axle assembly and a front axle assembly in various motor vehicles.

### SUMMARY OF THE INVENTION

Briefly, the present invention comprises a tool especially adapted for installation of both a rear and front axle seal for a particular model vehicle. That is, for each model of a vehicle, the front axle seal is generally unique in size and configuration vis-à-vis the seal for the rear axle. However, a front axle seal and rear axle seal will each generally have the circular form. Nonetheless, each front axle seal typically has a diameter and other associated dimensions distinct vis-à-vis the seal associated with the rear axle. The present invention comprises a tool which is useful for installation of the rear or front axle seals for a particular model of a vehicle. That is, the tool includes a body member or seal driver which is reversible and may be attached to a handle or shaft in one of two orientations depending upon whether the rear axle or the front axle of the vehicle is being serviced. Attachment of the seal driver or body member to the handle or shaft is effected by means of a fastener. The fastener may thus be used to attach the body member or seal driver to a handle in a first orientation thereby providing a tool for placement and insertion of a rear axle seal. Alternatively, the body or driver may be reversed in orientation relative to the shaft or handle, and held attached thereto by means of a fastener, to provide a tool for attachment of a front axle seal.

The body member or seal driver is comprised of a generally cylindrical body section with an axial throughbore comprised of opposed, first and second counterbores. The counterbores each define annular projections that extend axially from the body member in opposite directions. A groove is defined in the body member adjacent each annular projection for receipt of a specifically sized seal so that the appropriately sized seal may be placed over and retained on the annular projection sized to receive the seal. The body member with the appropriate seal thereon may then be directed into the matching seal housing and the seal driven into the rear axle or front axle housing as the case may be. The fastener for attaching the body member to a driver handle comprises a bolt which fits through the axial counterbores in a first direction or a second direction depending upon the orientation of the body member or driver with respect to the shaft or handle, which, in turn, is dependent upon the seal placed on the body member.

Thus, it is an object of the invention to provide an improved rear and front axle seal installation tool comprised of basically two component parts; namely, a driver or body member and a handle or shaft wherein the body member or driver is reversibly attachable to the handle or shaft.

A further object of the invention is to provide an inexpensive yet rugged and easy to utilize rear and front axle seal installation tool.

Another object of the invention is to provide a rear and front axle seal installation tool which may be easily assembled to accommodate the axle which is being serviced by a mechanic.

Another object of the invention is to provide a rear and front axle seal installation tool which incorporates a handle or shaft that is elongate so as to enable placement of a driver or body member of the tool in a position that is otherwise highly inaccessible enabling a mechanic to effect a repair with a minimum of disassembly of the component parts associated with the vehicle.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an exploded isometric view depicting the component parts of the tool;

FIG. 2 is a cross sectional view of the driver or body member of the tool;

FIG. 3 is a right end view of the body member of FIG. 2;

FIG. 4 is an opposite end view of the body member of FIG. 1 as viewed from the left hand side of the body member depicted in FIG. 2;

FIG. 5 is a side, partial cross sectional view of the driver shaft or handle for the seal installation tool of the invention;

FIG. 6 is an end view of the driver or handle of FIG. 5 as viewed from the left hand end thereof;

FIG. 7 is an isometric view of the tool of the invention positioned for installation of the rear seal in an axle housing;

FIG. 8 is an isometric view of the same tool configured to install the front seal in an axle housing and wherein the body member of the tool has been reversed relative to the position thereof in FIG. 7;

FIG. 9 is a side view illustrating the manner in which a seal is gripped or maintained by the seal installation tool of the invention for positioning and engagement into an axle housing; and

FIG. 10 is a side cross sectional view of a typical seal as mounted on the tool for installation.

### DESCRIPTION OF THE PREFERRED EMBODIMENT

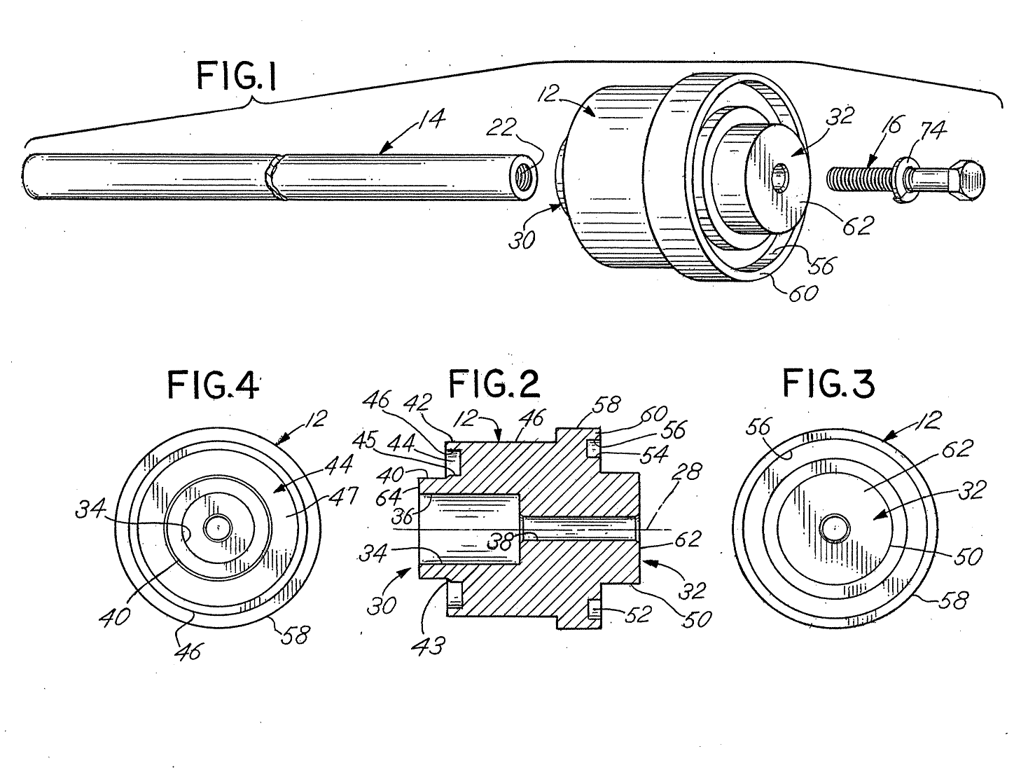

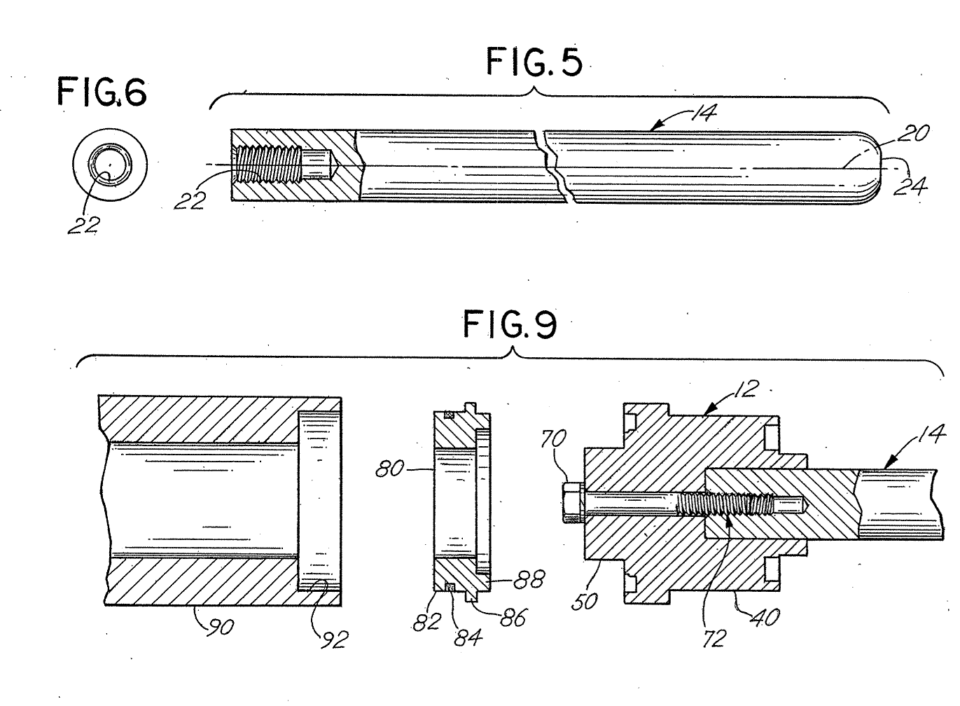

Referring first to FIGS. 1-6, there is depicted the component parts of the tool comprising the invention. The tool includes, in the embodiment depicted, three basic parts: a body member or driver 12, a generally cylindrical shaft or handle 14 and a fastener 16. Referring first to the handle 14, the preferred embodiment is depicted in FIGS. 5 and 6. The handle 14 thus comprises an elongate shaft generally cylindrical in configuration with a center line axis 20 and a threaded counterbore 22 at a first end and a driving surface 24 at its opposite end. Typically, the handle 14 will be at least about five times the axial dimension of body member 12 in the range of 20-30 inches in length and typically will have a diameter in the range of approximately ¾ inch. The handle 14 is made from a metal material, for example, aluminum. Aluminum is a preferred material inasmuch as it is a lighter weight material which is easier to lift and manipulate.

FIGS. 2, 3 and 4 illustrate the driver or body member 12. The body member or driver member 12 has a generally cylindrical configuration and is symmetrical about a centerline axis 28. The body member 12 further comprises a first end configuration 30 extending axially along the axis 28 in a first direction and a second end configuration 32 extending in the opposite axial direction from the first end configuration 30. A throughbore 34 extends axially through the body member 12 from the first end configuration 30 through the second end configuration 32. The throughbore 34 is comprised of a first, larger diameter, cylindrical counterbore 36 connected to a second, smaller diameter, cylindrical counterbore 38 comprising part of second end configuration 32. The first counterbore 36 is bounded by a cylindrical, larger diameter outer wall surface 40 which, in combination with an inclined connecting wall surface 43 and a second cylindrical outer wall 42, defines a circular or annular groove 44. The groove 44 is thus generally defined by the wall surface 40, connecting wall surface 43, wall surface 45, annular surface 47 and interior cylindrical surface 46 of the next adjacent, larger diameter outer wall 42. The first end configuration 30 thus has a groove 44 for receipt of a compatibly sized seal assembly mounted on surface 40 as depicted in FIG. 9. FIG. 10 is a sectional view of a seal 51 placed on first end configuration 30.

The second end configuration 32 of the body member 12 includes a cylindrical surface 50 which is adjacent a circumferential or circular groove 52. The groove 52 includes an inner diameter surface or dimension 54, and an outer diameter surface or dimension 56. Surface 56, in combination with an outer cylindrical surface 58, defines an outside wall 60.

The groove 52 as well as the groove 44 are spaced axially less than the axial spacing of outside face 62 of the second configuration 32 and the outside face 64 of the first configuration 30, respectively. Thus, the face 62 is positioned outwardly axially from the groove 52. The face 64 is positioned outwardly, axially from the groove 44.

The third component of the tool is the fastener 16 which is a bolt with a head 70 and a threaded shaft 72. An optional washer 74 may be included. The threaded shaft 72 is sized to fit within the threaded opening 22 of the handle 14. Thus, the fastener 16 may be fitted into the counterbore 38 and the end of the shaft or handle 14 fitted into the counterbore 36. The fastener 16 may then be tightened to retain the handle 14 within the counterbore 36.

The body member 12 may also be reversibly attached to the handle 14. That is, the shaft 72 of the fastener 16 may be inserted through the counterbore 36 axially into the counterbore 38 where it may be threaded to the threaded opening 22 of the handle 14 which is fitted against the outer face 62 of the body member 12. As a consequence, the driver or body member 12 is reversibly attachable to the handle 14.

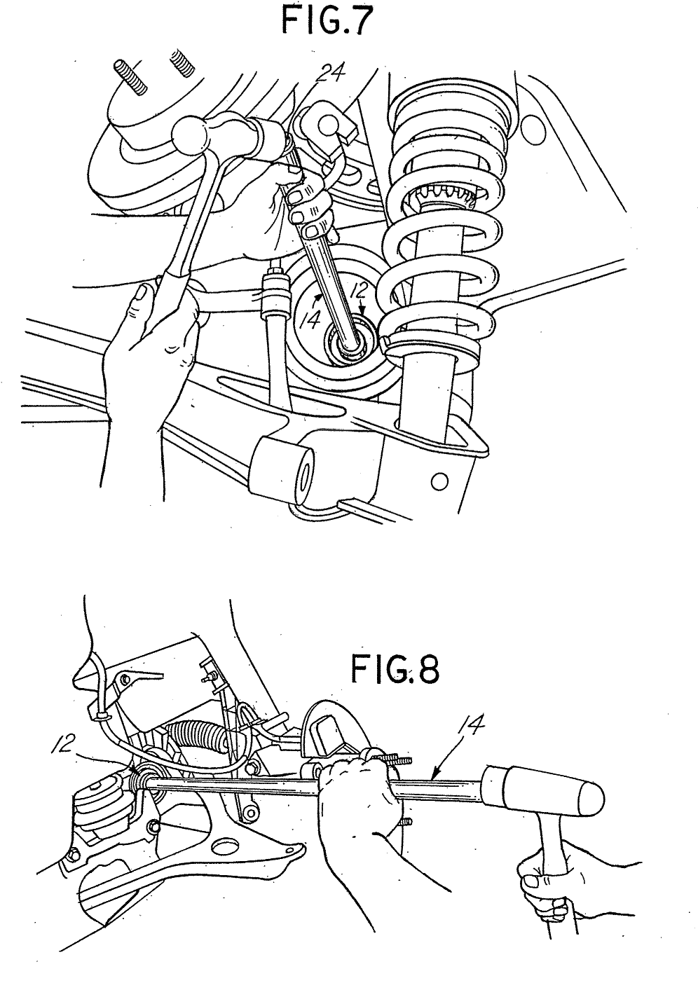

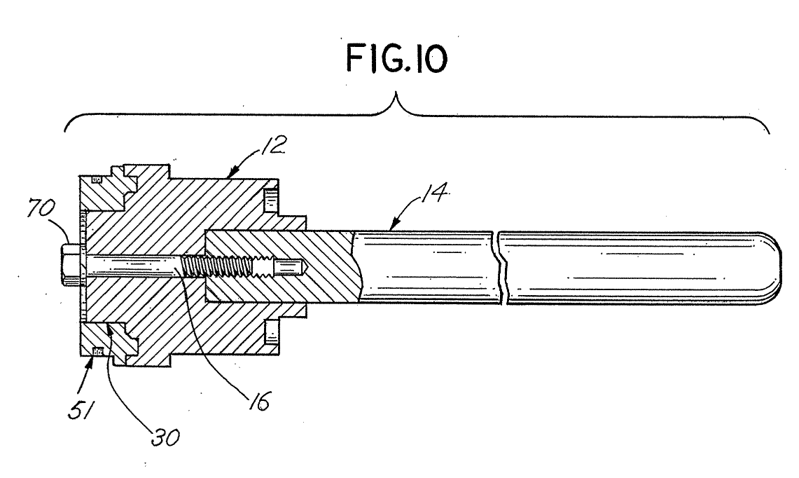

The first end configuration 30 and the second end configuration 32 are dimensioned and sized so as to be compatible with an appropriate seal associated with a rear seal or a front seal, respectively, of the motor vehicle being repaired, as the case may be. Thus, FIG. 9 illustrates a typical seal assembly 80 and the tool configured to place the seal 80 i8n a housing 90. A typical seal assembly may include an annular inside section 82 with sealing material 84 inserted in a peripheral outside surface groove. The seal assembly 80 further includes a flange 86 and a further annular section 88. The sealing section 82 fits within a seal housing 90 and more particularly into a counterbore 92 in the seal housing 90. The annular seal components are thus designed to be press fit into the seal housing 90. More specifically, the seal assembly section 80 is engaged over the outer cylindrical surface 50 and held in position of the body member 12. The section 88 fits generally within groove 52 and is driven by impacting the handle 14. Thus, for example, as illustrated in FIG. 7, the handle 14 may be driven by a tap with a hammer to insert an appropriate seal assembly 80 into a seal housing, for example a rear seal housing.

FIG. 7 illustrates the orientation of the component parts as also depicted in FIG. 9. The body member 12 may be, however, reversed on the handle 14 as previously described so that a seal member compatible with a front seal installation, for example, may be fitted over the cylindrical section 40 and thereby positioned within a seal housing associated with a front axle, for example.

As can be appreciated, the various dimensional characteristics of the grooves and cylindrical surfaces and bores may be altered during manufacture of the body member 12 to accommodate at least two sizes of seal members per body member 12. Thus, a body member 12 may be customized to provide for insertion of the rear and front axle seals associated with a particular model vehicle. In that context, with respect to such a vehicle, the tool is capable of providing a universal means for inserting both front and rear axle seals. Thus, one tool may be used for a different vehicle model rather than a multiplicity of separate tools. Converting the tool between its configuration for front and rear axle assembly is consequently straightforward. Note, in the embodiment depicted, the diametral dimension of surface 50 is less than that of surface 40, and the diameter of associated counterbore 38 is less than the diameter of counterbore 36.

It is possible to vary the construction of the body member, shaft or handle and other component parts to provide for servicing of particular models of vehicles. Each tool will therefore accommodate at least two differently sized seal members. As a consequence, the invention is limited only by the following claims and equivalents thereof.

What is claimed is:

1. A universal tool for installation of an annular seal for a front axle or a rear axle, said front axle seal having a diametral size distinct from the diametral size of said rear axle seal, said tool comprising, in combination:
a body member having a cylindrical configuration with a centerline axis, a first end configuration normal to the axis and a second end configuration normal to the axis,
a centerline throughbore comprised of first and second coaxial, connected counterbores, said first counterbore having a diameter greater than the diameter of the second counterbore, said first end configuration in the form of a first annular ring having an inner wall comprised of the first counterbore and extending axially outward from the body, said first annular ring surrounded by a first annular groove comprised of the first annular ring and a second annular ring having an inner diameter greater than the outer diameter of the first ring and an outer diameter to provide a first annular outer wall of said first annular groove, said first outer wall having a lesser outward axial extent than the axial extent of the first annular ring;
said second end configuration comprising a third annular ring extending in the opposite axial direction from the first end configuration and having an outside surface diameter greater than the outside surface diameter of the first annular ring and an inside diameter comprising the diameter of the second counterbore,
said second end configuration further comprising a second annular groove comprised of the outer diametral surface of the third annular ring and the inner diametral surface of a second annular outer wall, said second annular outer wall including a cylindrical outside surface and said second annular outer wall extending axially in a direction opposite the first annular wall for a lesser extent than the axial extent of the third annular ring;
an elongate shaft insertable into the first counterbore;
a fastener for passage through the second counterbore to engage and hold the shaft in the first counterbore projecting axially with the second end configuration positioned for receipt of a seal, said shaft also attachable to the second end configuration to extend axially therefrom by means of the fastener positioned in the first counterbore and extending through the second counterbore in a direction for connection of the shaft to the third annular ring with the first end configuration thereby positioned for receipt of a seal.

2. The tool of claim 1 wherein the shaft is elongate and cylindrical with an outer driving end.

3. The tool of claim 1 wherein each groove is sized to receive an annular seal of compatible size.

4. The tool of claim 1 wherein the maximum axial dimension of the shaft is greater than about five times the maximum axial dimension of the body member.

5. The tool of claim 1 wherein the shaft has a diametral dimension substantially the same as that of the first counterbore.

6. The tool of claim 1 wherein the diametral dimension of the first annular ring is less than the diametral dimension of the third annular ring.
